(19) United States
(12) Patent Application Publication
(10) Pub. No.: US 2019/0287419 A1
(43) Pub. Date: Sep. 19, 2019

(54) CODING TRAINING SYSTEM USING DRONE

(71) Applicant: WAVE3D CO.,LTD., Jeonnam (KR)

(72) Inventor: Kyung Sik SEO, Gwangju (KR)

(73) Assignee: WAVE3D CO.,LTD., Jeonnam (KR)

(21) Appl. No.: 16/195,760

(22) Filed: Nov. 19, 2018

(30) Foreign Application Priority Data
Mar. 13, 2018 (KR) 10-2018-0029344

(51) Int. Cl. G09B 19/00

(52) U.S. Cl. CPC G09B 19/0053

(57) ABSTRACT

The present invention relates to a coding education system, and more particularly, to a coding education system using a drone which enables to more effectively operate a programming education for controlling a drone. An exemplary embodiment of the present invention provides a coding education system using a drone comprising: a content database for storing coding education contents for a drone; a learning management database for storing information about a coding educatee and a coding educator, information about a registered user registered in association with the coding educatee, information about learning progress for coding educatee, and information about learning result for the coding educatee; a coding education server for managing a corresponding event as an event of the learning progress and the learning result occurs and providing a authoring tool for coding education to use the coding education contents stored in the content database; a user terminal for the registered user; a first educational terminal for the coding educatee; a second educational terminal for the coding educator; and an education site management device installed at a site where the coding education is performed to monitor the site.

### CROSS-REFERENCE TO RELATED APPLICATION

This application claims the benefit of the Korean Patent Application No. 10-2018-0029344, filed on Mar. 13, 2018, which is hereby incorporated by reference as if fully set forth herein.

### FIELD OF THE INVENTION

The present invention relates to a coding education system, and more particularly, to a coding education system using a drone which enables to more effectively operate a programming education for controlling a drone.

### BACKGROUND OF THE RELATED ART

Due to the development of hardware and network communication technology, various services through a communication network are being introduced, and many users are getting the information through the Internet. Recently, services for improving education, employment, and skills have been introduced

Meanwhile, efforts to raise creativity, also known as Computational Thinking (CT), which fit the digital era are taking place all over the place, and at the heart of that is coding education. The purpose of coding education is to teach the principles of the internet, smart phone, computer etc. used.

Such coding education is mandatory for elementary, middle and high schools, but there is no coding education using drone, which is the core of the fourth industry.

Although learning is being conducted using a teaching material such as robots similar to a drone and a textbook thereof, it is difficult to check whether the learning progress and the result are relevant, and there is no way to confirm how learning is actually conducted.

### SUMMARY OF THE INVENTION

The present invention is to provide a coding education system using a drone that facilitates confirmation for the learning progress and the result in the course of performing the coding education using the drone and allows the learning progress to be confirmed in real time.

### Technical Solution

An exemplary embodiment of the present invention provides a coding education system using a drone comprising: a content database for storing coding education contents for a drone; a learning management database for storing information about a coding educatee and a coding educator, information about a registered user registered in association with the coding educatee, information about learning progress for coding educatee, and information about learning result for the coding educatee; a coding education server for managing a corresponding event as an event of the learning progress and the learning result occurs and providing a authoring tool for coding education to use the coding education contents stored in the content database; a user terminal for the registered user; a first educational terminal for the coding educatee; a second educational terminal for the coding educator; and an education site management device installed at a site where the coding education is performed to monitor the site.

Preferably, the coding education contents stored in the content database include: regular learning contents fundamentally provided through the authoring tool, and user participating contents that are uploaded through the user terminal, the first and second educational terminals and converted to be usable in the authoring tool.

More preferably, the coding education server includes a registration management unit for converting contents uploaded through the first and second educational terminals to generate the user participating contents in cooperation with the contents database and adding the version information to the generated user participating contents; a search management unit for searching for the regular learning contents and the user participating contents registered through the registration management unit by ranking according to the version information; a display management unit for displaying the regular learning contents and the user participating contents searched by the search management unit on a screen in search ranking; and a learning management unit for generating a learning progress event according to the coding education using the content displayed on the screen by the display management unit through the authoring tool, collecting the generated learning progress event to generate a learning result event, collecting data monitored by the education site management device to generate a monitoring event, and providing the generated events for a request through either the user terminal or the first and second educational terminals.

More preferably, the registration management unit provides a user interface for uploading at least one content through the screen, and the version information added to the content to be uploaded through the user interface includes a tag or index for identifying the type of the uploaded content, and time information on which the content is uploaded.

More preferably, the learning management unit stores the learning progress event, the learning result event, and the monitoring event in the learning management database, and stores the learning progress event, the learning result event, and the monitoring event in association with each piece of information about the coding educatee, the coding educator, and the registered user.

More preferably, the coding education server further comprises an evaluation management unit for receiving evaluation of the learning progress event, evaluation of the learning result event, and evaluation of the monitoring event from any one of the user terminal and the first and second educational terminals. In particular, the evaluation management unit automatically transmits the evaluation of specific event to the user terminal and the first and second educational terminals in real time.

More preferably, the monitoring event is generated by collecting images monitored in real time by the education site management device.

More preferably, the learning management unit streams the images monitored in real time by the education site management device to the user terminal when the monitoring event is requested from the user terminal.

### Advantageous Effects

According to the present invention, there are the following effects.

The learning progress and learning results of the coding education using the drone can be checked at any time by educatee and educator as well as the registered user (for example, an educatee's parent) related to the educatee. And, the site where the coding education is conducted can be confirmed in real time, thus securing the reliability of education.

In addition, it can also support evaluation of learning progress and learning results, which can increase educational attainment. It is also possible to monitor the site where the education is performed in real time and to guarantee the reliability of the education progress.

### BRIEF DESCRIPTION OF THE DRAWINGS

FIG. 1 is a diagram illustrating an overall configuration of a coding education system using a drone according to an exemplary embodiment of the present invention; and

FIG. 2 is a block diagram illustrating a detailed configuration of a coding education server in a coding education system using a drone according to an exemplary embodiment of the present invention.

### DETAILED DESCRIPTION OF THE PREFERRED EMBODIMENTS

Other objects, features, and advantages of the present invention will be apparent through a detailed description of exemplary embodiments referring to the accompanying drawings.

Hereinafter, a configuration and an operation of an embodiment of the present invention will be described with reference to the accompanying drawings and the configuration and the operation of the present invention illustrated and described in the drawings are described as at least one embodiment and the technical spirit of the present invention and a core configuration and an operation thereof are not limited thereto.

Hereinafter, a preferred embodiment of a coding education system using a drone according to the present invention will be described in detail with reference to the accompanying drawings.

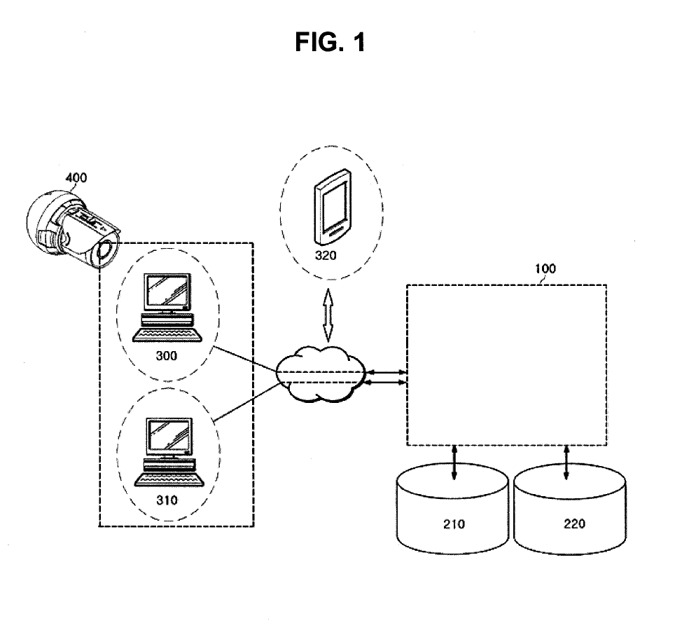

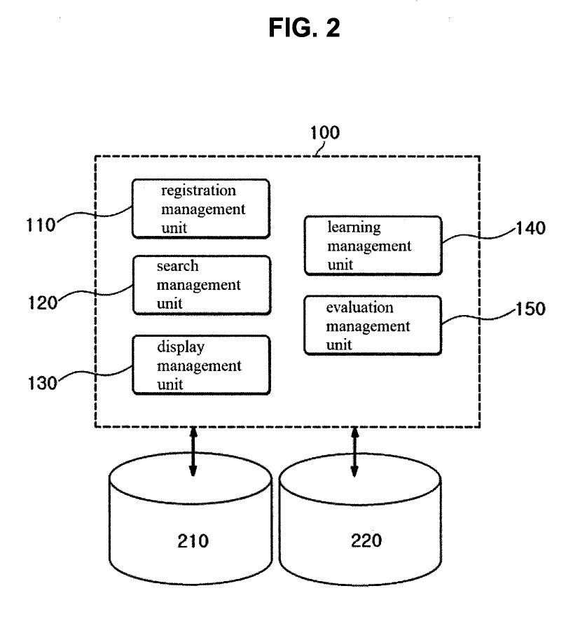

FIG. 1 is a diagram illustrating an overall configuration of a coding education system using a drone according to an exemplary embodiment of the present invention; and FIG. 2 is a block diagram illustrating a detailed configuration of a coding education server in a coding education system using a drone according to an exemplary embodiment of the present invention.

Referring to FIG. 1 and FIG. 2, a coding education system using a drone according to an embodiment of the present invention can be understood as a configuration in which a client and a server capable of ensuring mobility or capable of communication are connected through a communication network.

The server is connected to a plurality of clients through a communication network to form a client-server structure. Thus, the client corresponds to various terminals.

The server may be installed in a specific communication network, and the communication network in which the server is constructed may include a gateway for allowing a communication connection with a client accessing through various communication methods. Here, the gateway performs protocol conversion for connection between different communication networks.

The client may correspond to the first educational terminal 300, the second educational terminal 310, and the user terminal 320 that are connected to the server through various wired and wireless environments to provide services.

The client may be classified into a personal computer (PC) including a desktop computer or a tablet computer or a laptop computer, and a smart device including a PDA (Personal Digital Assistant) or a cellular phone or a smart phone, etc. In particular, in the case of the smart device, it can be classified into a PCS (Personal Communication Service) phone, a GSM (Global System for Mobile) phone, a W-CDMA (Wideband Code Division Multiple Access) phone, a CDMA-2000 phone, MBS (Mobile Broadband System) phone, and the like depending on a communication method.

Meanwhile, the communication network supporting the connection between the client and the server is not limited to the Internet but may be Code Division Multiple Access (CDMA), Wideband Code Division Multiple Access (W-CDMA), Global System for Mobile Communications (GSM), Long Term Evolution (LTE), and EPC (Evolved Packet Core), and may include a next generation mobile communication network or a cloud computing access network. Here, cloud computing means a computer environment in which information is permanently stored on a server on the Internet and temporarily stored on a client such as a desktop, tablet computer, laptop computer, netbook, or smart phone. Cloud computing access network means a computer environment access network that stores all information on a server on the Internet and makes the information available anytime and anywhere through various IT devices. Thus, the client can use various communication methods while having various forms.

In the present invention, a first educational terminal 300 is a terminal for a coding educatee, a second educational terminal 310 is a terminal for a coding educator, and a user terminal 320 is a terminal for a registered user registered in association with the coding educatee. For example, the first educational terminal 300 is a terminal used by a student, the second educational terminal 310 is a terminal used by a lecturer, and the user terminal 320 is a terminal used by educatee's parent.

The server is a core configuration in the system of the present invention, and corresponds to the coding education server 100 in the following description.

The coding education server 100 works with database storing information and contents necessary for a coding education.

The database worked with the coding education server 100 includes a content database 210 and a learning management database 220.

The content database 210 stores coding education contents for a drone.

The coding education contents stored in the content database 210 include regular learning contents fundamentally provided through the authoring tool for the coding education, and user participating contents that are uploaded through the user terminal 320, the first and second educational terminals 300 and 310 and converted to be usable in the authoring tool. In the above, the conversion of the content is to convert the file format, the file size, the resolution or the version so that the uploaded content can be used in the authoring tool.

The learning management database 220 stores the personal information of the user, learning history, learning results, and learning evaluation data, which are related to the coding education. That is, the learning management database 220 stores information about a coding educatee and a coding educator, and also stores information about a registered user registered in association with the coding educatee. And, the learning management database 220 stores information about learning progress for coding educatee, information about learning result for the coding educatee, evaluation of learning progress, and evaluation of learning result. In addition, the learning management database 220 can also store the evaluation inputted after confirming the education site where the coding education is actually performed. The stored evaluation corresponds to an evaluation that is monitored in real time by the education site management device 400 to be described later and fed back to the user terminal 320 and then fed back from the user terminal 320.

The coding education server 100 provides an upload environment of user participating content created by an individual to the first and second educational terminals 300 and 310 and user terminal 320 corresponding to clients, and provides an upload environment for evaluation information on learning progress and learning result.

The coding education server 100 manages the event corresponding to the learning progress and the learning result with respect to the coding education using the drones.

The coding education server 100 provides the authoring tool for coding education to the first and second educational terminals 300 and 310 so as to use the coding education contents stored in the contents database 210, and generates learning results using the input data of the first and second educational terminals 300 and 310.

The coding education server 100 will be described in detail with reference to FIG. 2.

The coding education server 100 includes a registration management unit 110, a search management unit 120, a display management unit 130, a learning management unit 140, and an evaluation management unit 150.

The registration management unit 110 converts contents uploaded through the first and second educational terminals 300 and 310 to generate the user participating contents in cooperation with the contents database 210, and adds the version information to the generated user participating contents when storing the user participating contents to the contents database 210. Here, the operation of storing to database can be understood as a registration.

The registration management unit 110 provides a user interface for uploading at least one content through a screen to the first and second educational terminals 300 and 310 and user terminal 320, and the version information added to the content to be uploaded through the user interface includes a tag or index for identifying the type of the uploaded content, and time information on which the content is uploaded. Such version information is preferably added to the regular learning contents.

The search management unit 120 searches for the regular learning contents and the user participating contents registered through the registration management unit by ranking according to the version information

The search management unit 120 preferably performs similarity search or content-based information search based on version information including the attribute information about the regular learning content and the user participating content, and uploaded time information when the searching is requested from the first and second educational terminals 300 and 310 and user terminal 320.

The display management unit 130 displays the regular learning contents and the user participating contents searched by the search management unit 120 on a screen in search ranking.

The learning management unit 140 generates various events using the contents displayed on the screen by the display management unit 130 through the authoring tool, and provides corresponding events in response to specific requests.

The learning management unit 140 generates a learning progress event according to the coding education using the content displayed on the screen by the display management unit 130 through the authoring tool, collects the generated learning progress event to generate a learning result event, collects data monitored by the education site management device 400 to generate a monitoring event, and providing the generated events for a request through either the user terminal 320 or the first and second educational terminals 300 and 310.

The learning management unit 140 stores the learning progress event, the learning result event, and the monitoring event in the learning management database 220, and stores the learning progress event, the learning result event, and the monitoring event in association with each piece of information about the coding educatee, the coding educator, and the registered user.

The learning management unit 140 may provide corresponding events for a request through either the first or second educational terminal 300 and 310 or the user terminal 320.

The evaluation management unit 150 receives evaluation of the learning progress event, evaluation of the learning result event, and evaluation of the monitoring event from any one of the user terminal 320 and the first and second educational terminals 300 and 310.

In particular, the evaluation management unit 150 automatically transmits the evaluation of specific event to the user terminal 320 and the first and second educational terminals 300 and 310 in real time. For example, when a feedback evaluation on a learning result event of coding educatee is input from the user terminal 320, the input evaluation may be automatically transmitted to the first and second educational terminals 300 and 310.

Meanwhile, the system according to the present invention may include an education site management device 400 installed at a site where coding education is performed so that the education site can be monitored in real time.

The education site management device 400 is for monitoring the site where the coding education is performed, and may be a device for capturing an image and a device for recording a voice. For example, the education site management device 400 corresponds to a camera and various sensors (such as an ultrasonic sensor, a radar sensor, or a voice recognition sensor).

For example, the monitoring events generated in the coding education server 100 may be generated by collecting images monitored in real time by the education site management device 400.

The learning management unit 140 of the coding education server 100 streams the images monitored in real time by the education site management device 400 to the user terminal 320 when the monitoring event is requested from the user terminal 320.

In addition, the user participating contents mentioned in the present invention may include various forms such as a map, video, audio, image, flash, 3D design, AR, VR, MR and the like.

Although preferred embodiments of the present invention have been described up to now, those skilled in the art will be able to implement in a modified form within a scope without departing from an essential characteristic of the present invention.

Therefore, the exemplary embodiments of the present invention described herein need to be considered from a limited viewpoint but an explanatory viewpoint and the scope of the present invention is shown in not the description but the claims and it should be interpreted that all differences within the scope equivalent thereto are included in the present invention.

### REFERENCE SIGNS AND NUMERALS

100: coding education server
210: contents database
220: learning management database
300: the first educational terminal
310: the second educational terminal
320: user terminal
400: education site management device

What is claimed is:

1. An exemplary embodiment of the present invention provides a coding education system using a drone comprising:
a content database for storing coding education contents for a drone;
a learning management database for storing information about a coding educatee and a coding educator, information about a registered user registered in association with the coding educatee, information about learning progress for coding educatee, and information about learning result for the coding educatee;
a coding education server for managing a corresponding event as an event of the learning progress and the learning result occurs and providing a authoring tool for coding education to use the coding education contents stored in the content database;
a user terminal for the registered user;
a first educational terminal for the coding educatee;
a second educational terminal for the coding educator; and
an education site management device installed at a site where the coding education is performed to monitor the site.

2. The system as claimed in claim 1, the coding education contents stored in the content database include: regular learning contents fundamentally provided through the authoring tool, and user participating contents that are uploaded through the user terminal, the first and second educational terminals and converted to be usable in the authoring tool.

3. The system as claimed in claim 2, the coding education server includes:
a registration management unit for converting contents uploaded through the first and second educational terminals to generate the user participating contents in cooperation with the contents database and adding the version information to the generated user participating contents;
a search management unit for searching for the regular learning contents and the user participating contents registered through the registration management unit by ranking according to the version information;
a display management unit for displaying the regular learning contents and the user participating contents searched by the search management unit on a screen in search ranking; and
a learning management unit for generating a learning progress event according to the coding education using the content displayed on the screen by the display management unit through the authoring tool, collecting the generated learning progress event to generate a learning result event, collecting data monitored by the education site management device to generate a monitoring event, and providing the generated events for a request through either the user terminal or the first and second educational terminals.

4. The system as claimed in claim 3, the registration management unit provides a user interface for uploading at least one content through the screen, and the version information added to the content to be uploaded through the user interface includes a tag or index for identifying the type of the uploaded content, and time information on which the content is uploaded.

5. The system as claimed in claim 3, the learning management unit stores the learning progress event, the learning result event, and the monitoring event in the learning management database, and stores the learning progress event, the learning result event, and the monitoring event in association with each piece of information about the coding educatee, the coding educator, and the registered user.

6. The system as claimed in claim 3, the coding education server further comprises an evaluation management unit for receiving evaluation of the learning progress event, evaluation of the learning result event, and evaluation of the monitoring event from any one of the user terminal and the first and second educational terminals.

7. The system as claimed in claim 6, the evaluation management unit automatically transmits the evaluation of specific event to the user terminal and the first and second educational terminals in real time.

8. The system as claimed in claim 3, the monitoring event is generated by collecting images monitored in real time by the education site management device.

9. The system as claimed in claim 8, the learning management unit streams the images monitored in real time by the education site management device to the user terminal when the monitoring event is requested from the user terminal.
